(19) United States
(12) Patent Application Publication
(10) Pub. No.: US 2006/0214874 A1
(43) Pub. Date: Sep. 28, 2006

(54) System and method for an interactive volumentric display

(76) Inventor: Jonathan Evan Hudson, Toms River, NJ (US)

Correspondence Address: Jonathan Hudson, 713 Woodchuck Lane, Toms River, NJ, 08755, US

(21) Appl. No.: 11/370,004

(22) Filed: Mar. 7, 2006

Related U.S. Application Data
(60) Provisional application No. 60/659,729, filed on Mar. 9, 2005.
(60) Provisional application No. 60/666,104, filed on Mar. 29, 2005.

(51) Int. Cl. G09G 5/00

(52) U.S. Cl. 345/6

(57) ABSTRACT

This invention is a volumetric display comprising multiple three-dimensional displays placed in a three-dimensional frame configuration so as to create multiple view three dimensional images that may be realistic, interactive or both with more clarity and interactivity than possible with a single three dimesional display, driven by a memory and controller, and for which communication may use wireless, touch screen, or wired communication methods.

### CROSS REFERENCE TO RELATED APPLICATIONS

This application claims the benefit of U.S. Provisional Patent Application Ser. No. 60/659,729 filed 2005 Mar. 9 and 60/666,104 filed 2005 Mar. 29 by the present inventor.

### FIELD OF THE INVENTION

This invention generally relates to electronic displays, specially to volumetric and autosteroscopic displays.

### BACKGROUND OF THE INVENTION

There are several autostereoscopic 3d LCDs. Some like SHARP's(R) 3d TFT display are limited to one viewer from a certain position and viewing angle. Some like SeeReal(R) C-Class use eye tracking to expand the viewing angle. Others are multi-view such as the Synthagram and Opticality's display. Yet all of these displays are limited to one view of a scene at a time.

Specialized glasses can also provide a 3d visualization, but the glasses are an hindrance in certain circumstances such as public displays.

### SUMMARY OF THE INVENTION

Accordingly, a system for showing a volumetric image on a plurality of displays is provided comprising a memory capable of storing the data for an image to be displayed, a plurality of displays capable of displaying a three-dimensional image, the displays are operatively connected to the memory, a frame for holding said plurality of displays in at least three dimensional configuration, a controller for coordinating the different views of the image to the displays, the controller operatively coupled to the memory and the displays, the controller coordinating the displays based on the image and the configuration of the displays in the frame.

Accordingly, process for generating volumetric images from a plurality of volumetric displays in a relative display configuration coupled to a memory and a controller is provided, comprising rendering a three-dimensional image using three dimensional image data in a memory using a controller, dividing the three dimensional image data into multiple views based on the number of volumetric displays and the relative display configuration in the memory using the controller, matching each of the multiple views to each of the displays; and, drawing each of the multiple views on each of the matched multiple displays from the memory and controller.

In one aspect, the interactive volumetric display provides a more precise, accurate, and intuitive interface to interact with data, especially three-dimensional data.

In one aspect, the interactive volumetric display provides a method to combine independent 3d displays that are not necessarily volumetric to create a volumetric display.

In one aspect, the interactive volumetric display provides a device that can be constructed without parts specifically manufactured for the device.

In one aspect, the interactive volumetric display may provide a touchscreen interface on at least one of the volumetric display screens of the device.

In one aspect, the interactive volumetric display may provide wireless communication between an external source of input and output and the device.

### DRAWINGS—FIGURES

FIG. 1a is one embodiment of the interactive volumetric display of the present invention.

FIG. 1b is a view of the frame for the embodiment of the invention shown in FIG. 1a.

FIG. 2a shows the interactive volumetric display with an image and the resulting estimated views shown on each panel, wherehe wires and stand of the display have been omitted for clarity.

FIG. 2b shows the display of FIG. 2a without a stand.

FIG. 2c shows the display embodiment of the invention of FIG. 2a with one type of stand.

FIG. 2d shows a wireless embodiment of the invention of FIG. 2a.

FIG. 3a shows one embodiment of the invention using standard multi-view auto-stereo LCDs and without a stand.

FIG. 3b shows a hand-held version of pne, embodiment of the invention with a manual shutter.

FIG. 4a shows one embodiment of the invention, fitted onto a hexagonal sphere.

FIG. 4b portrays one embodiment of the invention including a miniature version of the display fixated onto a surface and with two sides of the cube without displays.

FIG. 5a shows a top view of one embodiment of the invention.

FIG. 5b shows a side, isometric view of the embodiment of FIG. 5a.

### DETAILED DESCRIPTION

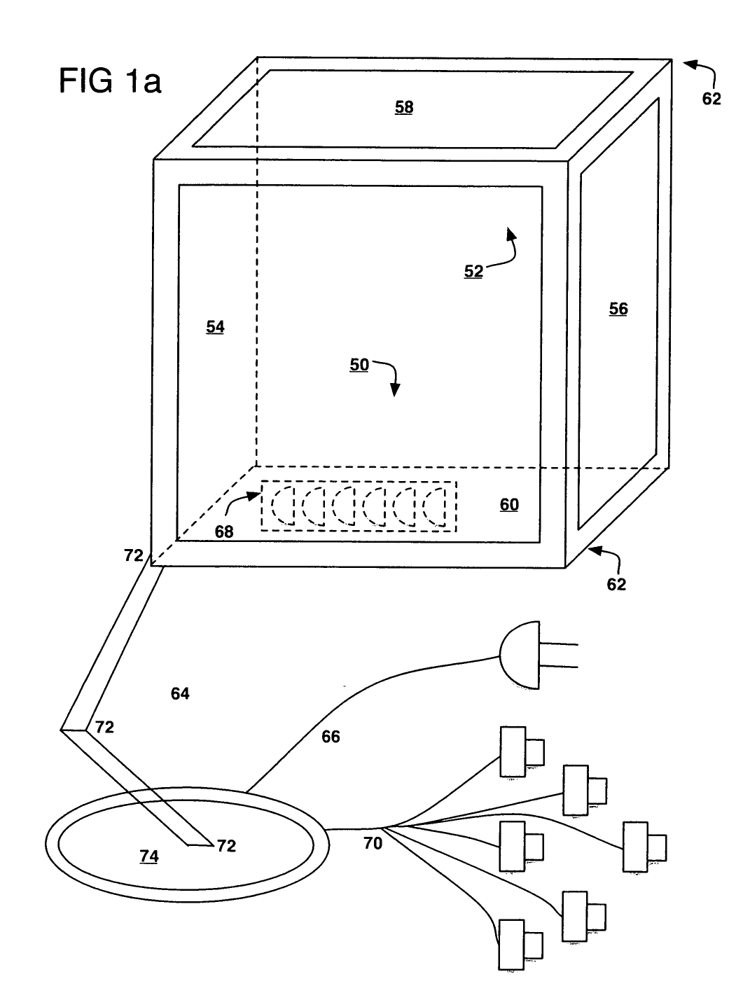

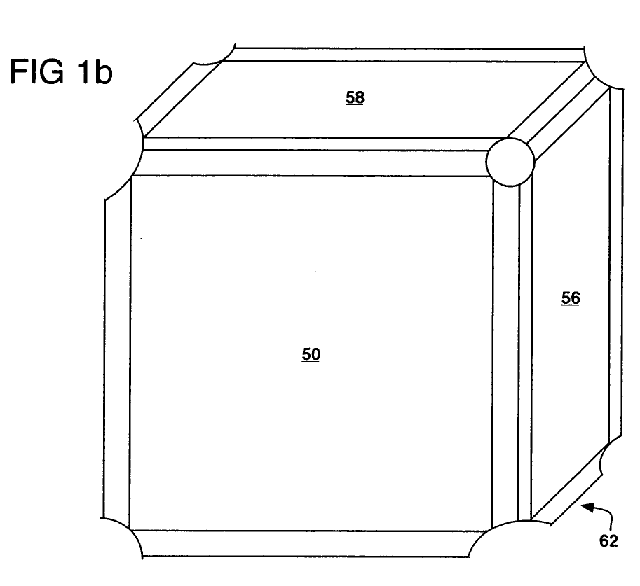

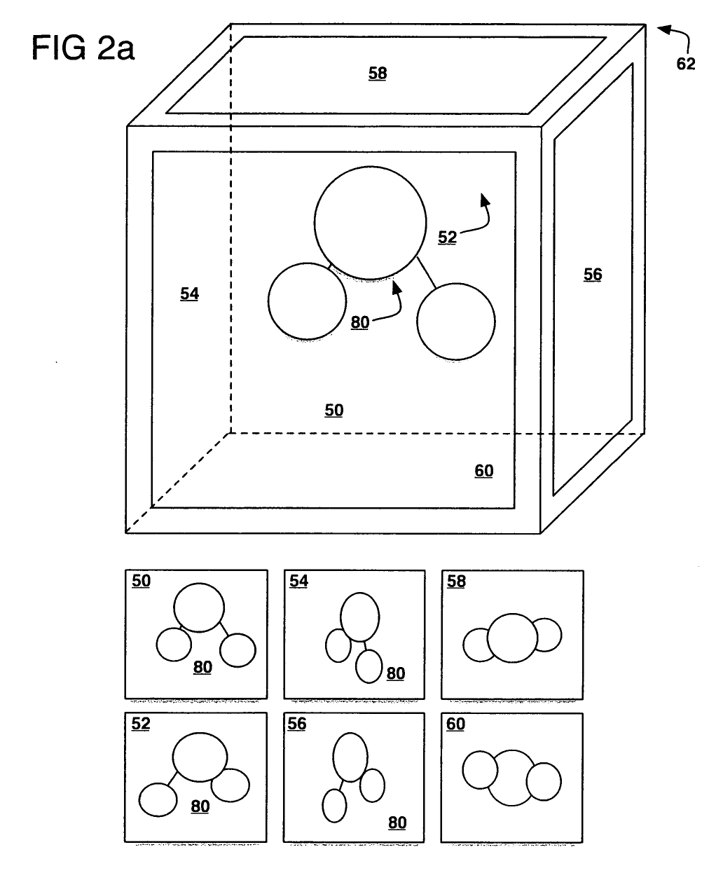

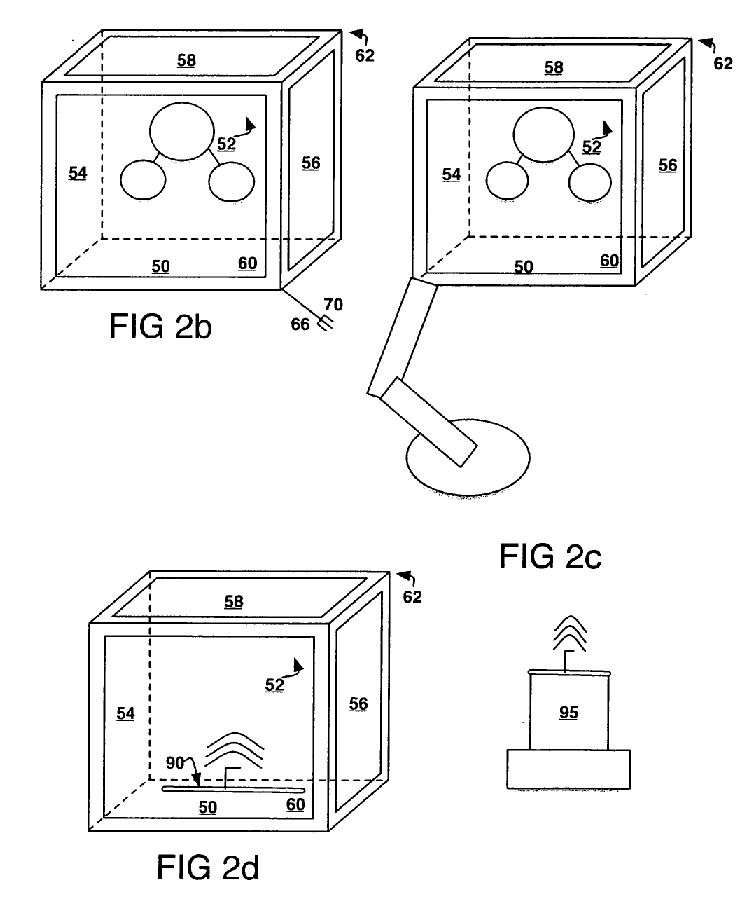

FIG. 1a illustrates of one of the embodiments of the invention. A power extension cord 68 with at least six electrical outlets is attached to inside the frame, although the form of power supply and number of power connections may vary from embodiment to embodiment. The power cord leaves through a designated hole in the frame's corner. The data cords for the LCD displays 50, 52, 54, 56, 58, and 60 also go through the same hole. The data cord connect to a 3d graphics card(s) capable of driving a total of six stereographic displays at once.

For LCD displays 50, 52, 54, and 56 (the front, back, left, and right displays,) the LCD display is attached to a side of the frame such that the display faces outward, and the bottoms of the LCDs are aligned. So long as the display faces outward, the alignment of displays 58 and 60 (the top and bottom displays) is up to the manufacturer so as to align the displays in any particular configuration to achieve a desired effect. The displays should be configured in such a way that they form a three dimensional configuration and are not all within a single plane or near a single plane (i.e. all within approximately 10 degrees of the same plane such as in three dimensional glasses). Moreover, while this embodiment foresees a frame with a single, predetermined three dimensional configuration of displays, it is within the scope of this invention to have an adjustable frame that permits the configuration of the displays to be changed based on the desired effect to be achieved. However, the choice affects the driving software. In the preferred embodiment the bottom of display 58 (the top display) is along the top of display 50 (front display,) and the bottom of display 60 (the bottom display) is along the bottom of display 52 (the back display.)

In one embodiment, for example, the processor used to drive the display is a standard PC running Windows XP or Linux with a Pentium IV processor coupled to 1 GB of SDRAM, with a video card such as an nVidia gForce with 256 MB of on-board memory, and where the displays are driven from the processor via VGA outputs or USB outputs. The processor may, however, be any processor capable of handling this system (either general purpose or specialty graphics processor) such as made by Intel, AMD, TI, IBM, SGI and the like. Similarly, any memory sufficiently fast to run the system, and any video card sufficiently fast to run multiple displays may be used. Any operating system may be used as well, and for specialty or portable embodiments, specialty portable or embedded components may be readily applied.

In this embodiment the display is a 3d multi-view auto-stereo LCD display technology such as Stereographics' Synthagram LCD monitor or an Opticality LCD display.

Ideally, the stand 64 is any which permits free movement of the cubic display. In this embodiment three hinges 72 permit movement caused by the user in all three directions. Any other stand which can be used that supports the cubic display's weight and permit free movement by the user. One such design is the flexible neck. The base of the stand 74 must be weighted such that it supports the cubic display at various positions.

The cube can be viewed from any angle. Although due to limitations in LCD technology, the view for some angles will be better than others.

Psuedo-code to drive the cubic display is as follows:

```
  void render_to_cube( )
{ // transformations from local space to world space
  local_to_world_transforms( );
  for(each side of the cube)
    stereo_render( camera[side] );
}
```

Essentially, for each side of the cube, one must drive it with an image that corresponds to the view which a user should see from that side. Code todrive the stero view is heavily dependent on the auto-stero technology used for the displays.

If Synthagram displays are used, then for each side nine views must be generated. Stereographics provides an software development kit to aid in programming the displays. If the Opticality displays are used, then only two views per display need to be generated.

Psuedo-code in OpenGL for generation of views in one simple embodiment is shown in Appendix A attached hereto.

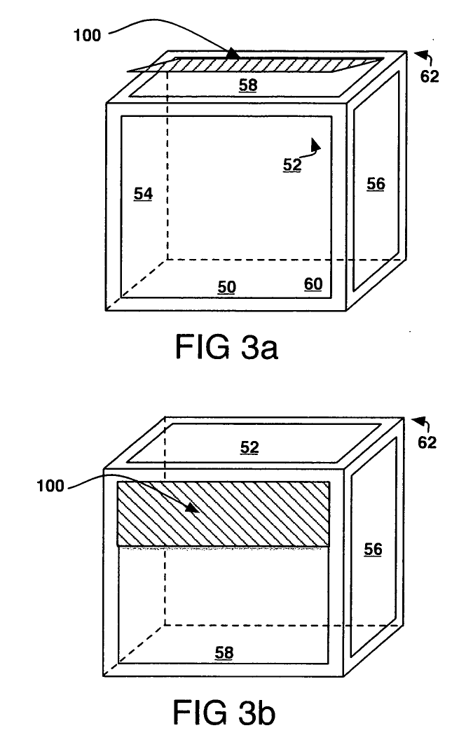

FIG. 3a shows the invention using standard multi-view autostereoscopic LCDs. Since standard multi-view autostereoscopic LCDs are not square, a gap will appear in the cube. In this case, the top and bottom have a gap. In the gap, controls or decorations may be placed.

A handheld version of the invention is shown in FIG. 3b. The necessary circuitry would be within the cube. To protect the LCDs when put onto a surface, a shutter on at least one side (but possibly on all sides) can be incorporated into the design.

The invention can be used as a replacement for a computer where one or more of the displays are touch-sensitive for input. In fact, controls can activate or deactivate the touch sensors to the users desires. Also, a tilt sensor can be included inside the cube. The driver can then compensate for the tilt of the cube so that it appears that the object in the cube does not rotate when the cube is rotated.

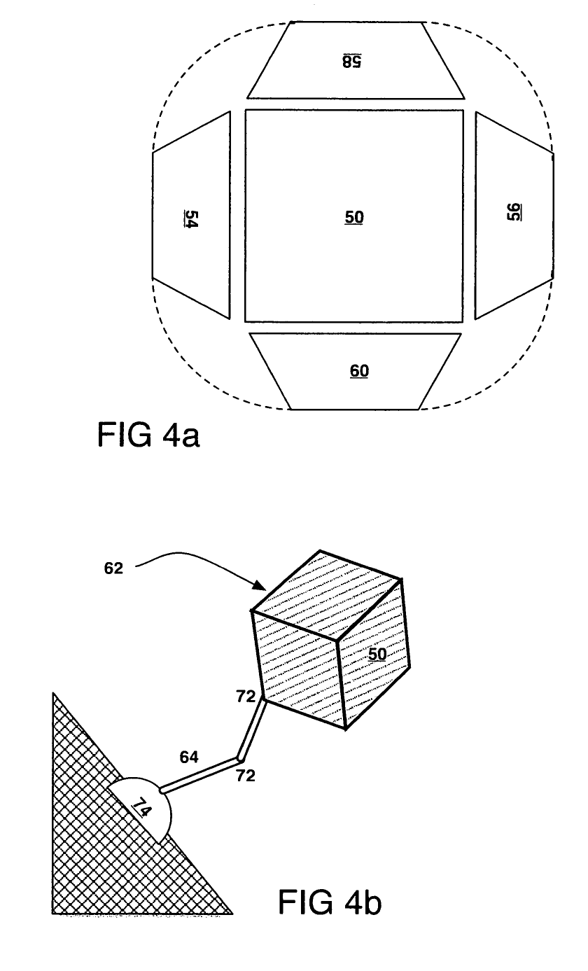

FIG. 4a shows an example of the invention using a polygonal shape other than a cube. The advantage of such a setup includes providing a different perspective and a wider viewing of the target object.

FIG. 4b portrays the invention as a small fixture somewhere such as by the control panel of a car. In such a situation, a virtual map of the surroundings can be shown on the cube.

In addition, a version of the invention cheaper uses normal LCDs for displays but requires the user to wear shutter eyewear such as Stereographics' CrystalEyes. Depending on the shutter eyewear technology used, addition hardware and software may be needed.

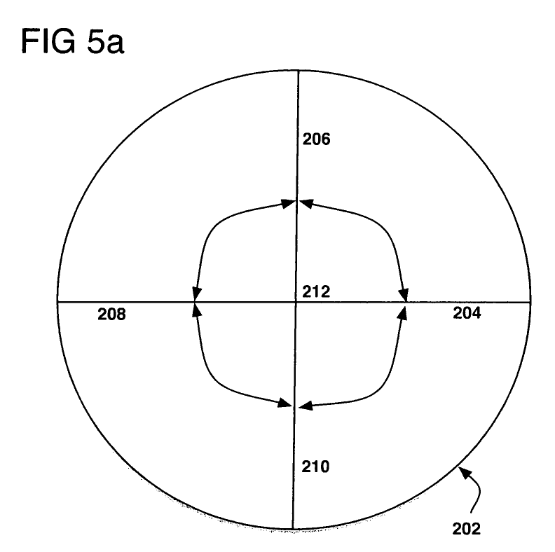

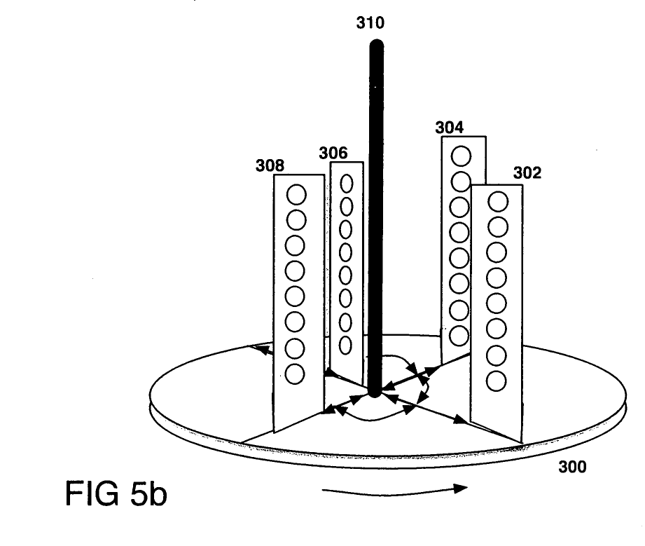

The displays need not necessarily be autostereospic LCD displays. For instance, a moving wand of LEDs, preferrably full color LEDs, using persistance of vision can be used as a displays. A known two-dimensional display can be constructed by using said wand moving left to right to left rapidly to produce a two-dimensional image display; however, the wand is not restricted to one dimensional movement, and the LEDs produce some depth to the image so it is approximately a three-dimensional display. To produce a three-dimensional image with volume, the wand can be moved in second dimensional. For instance, while the wand moves left to right to left, the wand also moves back and forth. Timing is important. The left-right-left motion must be faster than the back and forth motion (or visa versa.) To make one version of a volumetric display, see FIG. 5b. The wands 302, 304, 306, and 308 move both along the radius of the platform's circle and fourty-five degrees along the arc of the circle.

Accordingly, the reader will see that, according to the invention, a number of three-dimensional displays can be combined to produce a volumetric display. Furthermore, the volumetric display has the additional advantages in that:
it provides friendlier user interaction
it provides more information about data
it allows a volumetric display to be designed to be many different possible shapes and sizes

While the above description contains many specifications, these should not be construed as limitations on the scope of the invention, but as exemplifications of the presently preferred embodiments thereof. Many other ramifications and variations are possible within the teachings of the invention. For example, the invention can be shaped as a spherical, cup, pyramid, cylindrical, or other three-dimensional shape. The invention can be designed to be a fixture, handheld, or appliance. Buttons, a keyboard, game controllers or joysticks, acceleration and motion sensors, vibrators or other input and output devices and sensors can be incorporated into the invention. The image data can be obtained through different methods such as it can be generated by the computer processing unit or sent through a wireless connection (via, for one example, Bluetooth, 802.11x protocol systems, or other wireless communication protocols) or sent through wires.

Thus the scope of the invention should be determined by the appended claims and their legal equivalents, and not by the examples given.

### DRAWING—REFERENCE NUMERALS

50. Front 3d multi-view auto-stereo LCD display
52. Back 3d multi-view auto-stereo LCD display
54. Left 3d multi-view auto-stereo LCD display
56. Right 3d multi-view auto-stereo LCD display
58. Bottom 3d multi-view auto-stereo LCD display
60. Left 3d multi-view auto-stereo LCD display
62. Frame
64. Stand
66. Power Cords
68. Power Cord Extension
70. Data Cords with extensions
100. Manual Shutter or Cover
202. Platform
204. Persistance of vision wand with LEDs
206. Persistance of vision wand with LEDs
208. Persistance of vision wand with LEDs
210. Persistance of vision wand with LEDs
212. Center Pillar
300. Platform
302. Persistance of vision wand with LEDs
304. Persistance of vision wand with LEDs
306. Persistance of vision wand with LEDs
308. Persistance of vision wand with LEDs
310. Center Pillar

### APPENDIX A: OpenGL CODE

```
//
struct vector3_t {
  float x, y, z;
  vector3_t(float X, float Y, float Z)
    {x = X; y = Y; z=Z;}
  ...
};
struct Camera {
  vector3_t toward, up;
  int screen_width, screen_height;
  float aperture;
  float focal_length;
};
/*
```

This renders a stereo view to the active display. The exact code is dependent on the technology used for the multi-view stereo display.

```
*/
void stereo_look_at(const Camera &camera);
/*
  This creates a unit viewing cube centered at (0,0,0)
*/
void make_view_cube(Camera camera[6],
      const Camera &settings)
{
  for(int i=0; i<6; i++)
    camera[i] = settings;
  // Front display camera
  camera[0].toward = vector3_t(0,0,1);
  camera[0].up = vector3_t(0,1,0);
  // Back display camera
  camera[1].toward = vector3_t(0,0,−1);
  camera[1].up = vector3_t(0,1,0);
  // Left display camera
  camera[2].toward = vector3_t(1,0,0);
  camera[2].up = vector3_t(0,1,0);
  // Right display camera
  camera[3].toward = vector3_t(−1,0,0);
  camera[3].up = vector3_t(0,1,0);
  // Top display camera
  camera[4].toward = vector3_t(0,−1,0);
  camera[4].up = vector3_t(0,0,1);
  // Bottom display camera
  camera[5].toward = vector3_t(0,1,0);
  camera[5].up = vector3_t(0,0,−1);
}
// Renders all six views
void render_to_cube( )
{
  for(each side i of cube)
  {
    activate_display(i);
    stereo_look_at(camera[i]);
  }
}
```

1. A system for showing a volumetric image on a plurality of displays, comprising:
a memory capable of storing the data for an image to be displayed,
a plurality of displays capable of displaying a three-dimensional image, said displays are operatively connected to said memory,
a frame for holding said plurality of displays in at least three dimensional configuration;
a controller for coordinating the different views of the image to said displays, the controller operatively coupled to said memory and said displays, said controller coordinating the displays based on the image and the configuration of the displays in the frame.

2. The system of claim 1, wherein at least one of the displays of the plurality of displays is touch sensitive for input.

3. The system of claim 1, wherein the frame holds the plurality of displays in a cubic configuration.

4. The system of claim 1, wherein the controller and memory are held within the frame and are at least partially surrounded by said plurality of displays.

5. The system of claim 1, further including a wireless receiver coupled to said controller for at least one of receiving and transmitting wireless signals from the controller.

6. The system of claim 1, wherein the frame, display, memory and controller are configured so as to be held in the hand during operation.

7. The system of claim 2, wherein the frame, display, memory and controller are configured so as to be held in the hand during operation.

8. A process for generating volumetric images from a plurality of volumetric displays in a relative display configuration coupled to a memory and a controller, comprising:
rendering a three-dimensional image using three dimensional image data in a memory using a controller,
dividing the three dimensional image data into multiple views based on the number of volumetric displays and the relative display configuration in the memory using the controller,
matching each of said multiple views to each of said displays; and,
drawing each of said multiple views on each of said matched multiple displays from said memory and controller.

9. The method of claim 8, further comprising providing a touch-sensitive screen coupled to at least one of said displays for communication between a user of the display and the controller.

10. The method of claim 8, further comprising providing a wireless input/output interface coupled to the controller for communication between a user of the display and the controller.
